(19) United States
(12) Patent Application Publication
(10) Pub. No.: US 2016/0292636 A1
(43) Pub. Date: Oct. 6, 2016

(54) Systems and Methods for Managing Sending of Items

(71) Applicant: SENDLE PTY LTD, Glebe, New South Wales (AU)

(72) Inventors: James Moody, Glebe, New South Wales (AU); Kohei Nishiyama, Glebe, New South Wales (AU)

(21) Appl. No.: 14/778,235

(22) PCT Filed: Mar. 19, 2014
(86) PCT No.: PCT/AU2014/000293

§ 371 Date: Sep. 18, 2015

(30) Foreign Application Priority Data
Mar. 19, 2013 (AU) 2013901007

(51) Int. Cl. G06Q 10/08; H04L 12/58; G06Q 30/06

(52) U.S. Cl. CPC G06Q 10/0833; G06Q 30/0639; H04L 51/32; G06Q 50/01

(57) ABSTRACT

Methods and systems for managing the sending of items between users of an online service are disclosed. A request to transfer an item and location identifiers of a first and/or second user are received at a server. Instructions for transferring the item to a dispatcher are transmitted from the server. A code is received at the server from the dispatcher to notify the service that the item has been received and the server transmits location data to the dispatcher to enable the dispatcher to transfer the item to the second user. Alternatively, a code can be provided to the first user who will provide the code to a second user or the first user provides an email address of the second user and the server sends an email to the second user. The first and second users each provide location identifiers to enable a transfer service to transfer the item.

### FIELD OF THE INVENTION

The present invention relates to systems and methods of managing sending of items. In particular, the present invention relates to systems and methods of managing sending of items between peer users of an online service.

### BACKGROUND TO THE INVENTION

Many online services require goods to be sent between their users, usually as a result of online selling, trading, gifting, borrowing, bartering, swapping, renting or sharing. For online buying and selling, items are typically sent between users of these online services via postage using a postal or courier service, such as Australia Post, FedEx, UPS or US Postal. Usually postage via these services involves sending an item, for example in an envelope or a package, from a post box or post office to a receiving address. Posted items are typically labelled with the receiving address to notify the postal service of the item's destination and a sender's address to which the item is returned if delivery to the receiving address fails. A fee for postage is typically paid by the sender by purchasing one or more postage stamps and affixing the one or more postage stamps to the envelope or package. Alternatively, the sender may pay the fee for postage by purchasing a pre-paid envelope, parcel or satchel in which the item is to be posted.

This method of sending an item has a number of significant drawbacks when used to send an item between two peers of an online service. Firstly, this method of sending an item from one user to another often requires significant transaction costs on behalf of the sender. The sender must purchase stamps or prepaid envelopes, parcels or satchels to post the item, a process which can also be inconvenient and/or time consuming. For services involving gifting, bartering, swapping or borrowing, which do not involve a financial transaction or rely on the goodwill of the sender, the cost of purchasing stamps or prepaid postage may be prohibitively large and discourage the user from using the service.

A second problem with posting an item between users of an online service is that it is difficult for the online service to track the item. This means that when an item is not received or is damaged when received by a user, the user sending the item can suggest that the item was lost or damaged by the postal service. In such disputes, it is difficult for the online service to mediate, because the online service has no reliable record of whether the item was posted, whether the item was packaged correctly, and/or the condition of the item prior to postage. While some postage services provide the option of registered post wherein a first user who is sending the item may receive a tracking number from the postal service, this often comes at an additional cost and relies on the goodwill of the first user supplying this tracking number to the service or a second user who is receiving the posted item, so that the second user can track the postage.

A further problem with sending items between users of an online service via standard or registered post is that the receiving user must disclose their personal details such as their name and address to the sending user. In the event two users are unfamiliar with one another, there is no mechanism for the two users to remain anonymous to each other and retain personal privacy. Furthermore in non-trusted environments there is no mechanism for a third party to inspect the package for safety purposes.

U.S. Pat. Nos. 4,816,824 and 5,971,587 teach tracking of an item by attaching a tag to the item and using authentication devices to recognize the item. However, these tags are designed for commerce between merchants and customers, and require a merchant to have access to printing devices or the ability to pre-purchase and attach the tags.

U.S. Pat. Nos. 7,295,997, 7,376,598 and 7,848,961 (all to Estes et al.) teach systems and methods to allow a customer to anonymously purchase and receive an item from an online merchant's web site. In each of the systems and methods, in advance of conducting e-commerce a customer must purchase a token which contains their encrypted address details. When making a purchase the user provides this token and is redirected from a merchant's website to a payment website, where the customer may be quoted and pay a shipping amount to a shipper. Upon payment a shipping label is provided to the merchant by the shipper. The label may contain a bar code or number representation of a re-labelling location and a unique identifier corresponding to the customer. The merchant prints and attaches the shipping label to a package containing the purchased item and posts the package to a re-labelling location where the unique identifier of the package is read or scanned to determine the customer's name and address, and the package is then relabeled.

The solution taught in each of the US patents to Estes et al. is used for transactions between merchants and customers rather than between two peers of an online service. For example, while the solution provides anonymity for the customer from the merchant, it does not consider anonymity for the merchant from the customer.

The system taught in the US patents to Estes et al. is also complex, relying on both the merchant and the customer to undertake a key number of steps in advance of the transaction. For a customer to maintain anonymity, the customer must first log into a shipping company website and retrieve a token before completing a transaction with an online merchant. Furthermore, the customer must visit three separate web sites, namely those of the merchant, the shipping company and the payment company, to complete the purchase of a product. For the merchant, the systems and methods taught by Estes et al. require agreements to be in place between the merchant, the payment company and the shipper to perform the invention. Moreover, the system described by Estes et al requires the user to enter their token information before postage costs can be calculated.

A further problem is that the system of Estes et al. uses a unique identifier corresponding to a customer. This allows a customer's name and address to be retrieved from a database and placed on a shipping label on the package, but does not provide a means to monitor or track an individual item.

A further limitation of the systems and methods taught by Estes et al. is that to verify that the postage has been paid, a shipping label must be received, printed and placed on the package before postage. Therefore, Estes et al. requires that the merchant has appropriate backend software, a printer and other suitable stationery to print and attach such a shipping label.

US patent publication number 2001/0044785 teaches preventing a merchant from electronically capturing a customer's details. In the primary embodiment of the invention a proxy name, proxy email address and proxy postal address are received by the merchant from the customer. The merchant transmits the proxy address to a shipper and receives a shipping label containing the true address of the customer. This prevents the merchant from easily storing the address of the customer and therefore increases the level of privacy for the customer. While this invention prevents the customer's name and email address from being known by the merchant, the customer is not completely anonymous because the merchant is only prevented from storing the customer's address. Furthermore, the invention of US patent publication number 2001/0044785 requires the customer to purchase the proxy postal address in advance and requires the merchant to install software to receive the true address from the shipper.

### OBJECT OF THE INVENTION

It is a preferred object of the embodiments of the present invention to provide a system and method that address or at least ameliorate one or more of the aforementioned problems of the prior art and/or provide a useful commercial alternative.

### SUMMARY OF THE INVENTION

Generally, embodiments of the present invention relate to systems and methods of managing sending of items. In particular, the present invention relates to systems and methods of managing sending of items between peer users of an online service.

According to one aspect, but not necessarily the broadest aspect, the present invention resides in a method of managing sending of items between users of an online service, the method comprising:

receiving at a server of the service a request to transfer an item from a first user to a second user;

receiving at the server from the second user a second location identifier of the second user;

transmitting from the server to the first user instructions to transfer the item to a dispatcher;

receiving at the server from the dispatcher a code read from the item to notify the service that the item has been received by the dispatcher; and

transmitting from the server to the dispatcher location data corresponding to the second location identifier that corresponds to the code to enable the dispatcher to transfer the item to the second user.

According to another aspect, but not necessarily the broadest aspect, the present invention resides in a system to manage sending of items between users of an online service, the system comprising:

a server of the service, the server coupled to a communications network;

a first computer of a first user, a second computer of a second user and a third computer of a dispatcher coupled to the server via the communications network; and

wherein the server:
receives via the communications network a request to transfer an item from the first user to the second user;
receives via the communications network a second location identifier of the second user from the second computer;
transmits via the communications network to the first computer instructions to transfer the item to a dispatcher;
receives via the communications network from the third computer a code read from the item to notify the service that the item has been received by the dispatcher; and
transmits via the communications network to the third computer location data corresponding to the second location identifier corresponding to the code to enable the dispatcher to transfer the item to the second user.

Preferably, the code corresponds to the request or the transfer of the item.

Preferably, the code is transmitted from the server to the first user.

Preferably, the code is unique to the request, the transfer of the item and/or the location identifier of the second user.

Suitably, the code has a coding redundancy to enable the code to be decoded when the code is not completely legible or is damaged in some way.

Suitably, the code can be understood by and transcribed by a human using handwriting with a low probability of transcription errors.

Suitably, the code is read from the item by the dispatcher scanning the code.

Suitably, the code is a text code to enable the first user to write the code on the item or on a package containing the item.

Suitably, the location data is transmitted from the server to the third computer in response to the reception of the code at the server from the third computer.

Suitably, the location data is transmitted from the server to the third computer with the unique code prior to the reception of the code at the server from the third computer.

Suitably, the second location identifier identifies an address.

Suitably, the second location identifier identifies a city, a post code or a GPS location.

Preferably, the first user can transfer the item to the dispatcher without the first user purchasing stamps or paying for postage.

Preferably, the service receives from the first user a first location identifier of the first user.

Preferably, the instructions to transfer the item to the dispatcher are determined from the first location identifier.

Preferably, the first location identifier identifies a region, a city, a country, a post code, an address or a GPS location.

Suitably, a request to pay a transfer fee is transmitted from the server to the second user, first user and/or a third party.

Suitably, a subscription to the service by the first user, the second user or a third party is used to pay a transfer fee.

Preferably, the transfer fee is for transfer from a location of the first user corresponding to the first location identifier to a location of the second user corresponding to the second location identifier and includes any additional costs such as import and/or export duties and insurances.

Suitably, there are a plurality of dispatching points located to improve the efficiency of the service.

Suitably, the dispatcher is a postal service or a courier service.

Suitably, the item is received by the dispatcher at a distribution centre of the postal service or the courier service, or at a location associated with the first location identifier.

Suitably, the instructions to transfer the item from the first user to the dispatcher are determined from the party paying the transfer fee for the transfer.

Suitably, the instructions to transfer the item from the first user to the dispatcher are determined from a selection of a first transfer method received by the server from the first user and/or the second user.

Suitably, the first transfer method is by receiver-pays postage from the first user to the dispatcher.

Suitably, the first transfer method is by pick up of the item from a location of the first user corresponding to the first location identifier.

Suitably, the first transfer method is by drop off by the first user at the dispatcher or another location specified in the instructions.

Preferably, the instructions to transfer the item from the dispatcher to the second user are determined from a selection of a second transfer method received by the server from the first user, the second user or the party paying the transfer fee.

Suitably, the second transfer method is by postage or courier from the dispatcher to the second user.

Suitably, the second transfer method is by pick up by the second user from the dispatcher or another location.

Suitably, the server receives from the dispatcher one or more attributes of the item, such as the weight and/or condition of the item.

Suitably, the service inspects the item using mechanisms such as chemical analysis or imaging techniques, for purposes such as security checking.

Preferably, the server transmits to the dispatcher instructions to modify the item, such as clean, repair or gift wrap the item.

Suitably, the server transmits to the dispatcher details of advertising to be attached to the item or on a package containing the item.

Suitably, the server transmits to the dispatcher codes of other transfers to be received by the second user to enable the dispatcher to transfer a plurality of items to the second user as a single transfer.

Suitably, the dispatcher receives a plurality of items from the first user and distributes the items to a plurality of second users

Suitably, the server transmits an update to the first user, the second user and/or a third party to enable the first user, the second user and/or the third party to track the transfer of the item.

Suitably, the server posts the status of the item to a social network service, website or microblog on behalf of the first user, the second user or a third party.

Suitably, the second user transmits feedback to the service, the feedback rating of the quality of the item or the packing of the item by the first user.

According to another aspect, but not necessarily the broadest aspect, the present invention resides in a method of managing sending of items, particularly between peers and more particularly without the peers having to share location information with one another, the method comprising:
receiving at a server of a service from a first user:
   a request to transfer an item;
   a location identifier of the first user; and
   contact information of a second user other than a location identifier, the contact information being associated with a communication mechanism;
transmitting from the server to the second user via the communication mechanism using the contact information a request for a location identifier of the second user;
receiving at the server from the second user the location identifier of the second user; and
transmitting from the server to a transfer service the location identifier of the first user and the location identifier of the second user to enable the transfer service to transfer the item between the users.

According to another aspect, but not necessarily the broadest aspect, the present invention resides in a method of managing sending of items, particularly between peers and more particularly without the peers having to share location information with one another, the method comprising:
receiving at a server of a service from a first user:
   a request to transfer an item; and
   a location identifier of the first user;
transmitting from the server to the first user a unique code for the first user to provide to a second user;
receiving at the server from the second user the unique code and a location identifier of the second user; and
transmitting from the server to a transfer service the location identifier of the first user and the location identifier of the second user to enable the transfer service to transfer the item between the users.

Preferably, a request for a location identifier of the first user is transmitted from the server to the first user.

Preferably, a request for contact information of the first user other than a location identifier is transmitted from the server to the first user.

Preferably, the contact information of the first user other than a location identifier is received at the server from the first user, the contact information being associated with a communication mechanism.

Preferably, one or more requests from the server to the first user and/or the second user are transmitted via the communication mechanism using the contact information.

Suitably, the server stores the location identifier and/or the contact information of the first user and/or the second user for future uses of the service.

Suitably, the server comprises a database in which the location identifier of one or more users is associated with the contact information other than location identifiers of the one or more users.

Suitably, the location identifier of the first user and/or the location identifier of the second user are determined via the database.

According to another aspect, but not necessarily the broadest aspect, the present invention resides in a method of managing sending of items, particularly between peers and more particularly without the peers having to share location information with one another, the method comprising:
receiving at a server of a service from a first user:
   a request to transfer an item;
   a unique identifier for the first user other than a location identifier, the unique identifier being associated with a communication mechanism; and
   a unique identifier for a second user other than a location identifier, the unique identifier being associated with a communication mechanism;
determining via the server:
   a location identifier of the first user corresponding to the unique identifier of the first user; and
   a location identifier of the second user corresponding to the unique identifier of the second user; and
transmitting from the server to a transfer service the location identifier of the first user and the location identifier of the second user to enable the transfer service to transfer the item between the users.

Preferably, a request for the contact information or the unique identifier of the second user other than a location identifier is transmitted from the server to the first user.

Suitably, the contact information or the unique identifier of the first user and/or the second user includes a telephone number or an identifier for receiving messages via an online service.

Suitably, the identifier for receiving messages via an online service is an email address or an identifier for Skype, Viber, WhatsApp, Facebook, Google Plus or another similar online service.

Preferably, a request for confirmation that the second user wishes for the item to be transferred is transmitted from the server to the second user via the communication mechanism using the contact information or the unique identifier.

Preferably, confirmation that the second user wishes for the item to be transferred is received at the server from the second user.

Preferably, the service calculates a postage cost from the location identifier of the first user and the location identifier of the second user.

Suitably, the item is collected from a first location associated with the first location identifier by the transfer service and delivered to a second location associated with the second location identifier.

Suitably, the item is collected from a second location associated with the second location identifier by the transfer service and delivered to a first location associated with the first location identifier.

Preferably, a request for a collection time is transmitted from the server to the first user or the second user.

Preferably, the collection time is received at the server from the first user or the second user.

Preferably, the collection time is transmitted from the server to the transfer service enabling the transfer service to pick up the item at the collection time.

Suitably, the location identifier of the first user and/or the location identifier of the second user identifies a general location, a postcode, a suburb, a street address, a postal address or GPS coordinates.

Suitably, the location identifier of the first user and/or the location identifier of the second user identifies GPS coordinates.

Preferably, a unique code and instructions instructing the user to put the unique code on the item are transmitted from the server to the user from which the item is to be collected.

Preferably, a request to specify whether the first user, the second user or a third party will pay for the transfer of the item is transmitted from the server to the first user.

Suitably, confirmation that the first user will pay for the transfer of the item is received at the server from the first user and a request for payment for the transfer of the item is transmitted from the server to the first user.

Suitably, confirmation that the second user will pay for the transfer of the item is received at the server from the first user and a request for payment for the transfer of the item is transmitted from the server to the second user.

Suitably, confirmation that a third party will pay for the transfer of the item is received at the server from the first user and a request for payment for the transfer of the item is transmitted from the server to the third party.

Suitably, the payment for the transfer of the item is a first flat rate where the addresses of the first user and the second user are in the same city, and a second flat rate where the addresses of the first user and the second user are in different cities of the same country.

Preferably, a request to specify whether the contact information or the unique identifier and/or the location identifier of the first user or the second user is provided to the other user is transmitted from the server to the first user or the second user.

Suitably, confirmation that the contact information or the unique identifier of the first user or the second user is not to be provided to the other user is received at the server from the first user or the second user.

Suitably, the service charges an additional payment for not providing the contact information or the unique identifier of the first user or the second user to the other user.

Preferably, the item to be transferred must have a weight or volume that is less than a specified maximum weight or maximum volume.

Preferably, insurance is provided by the service covering loss or damage during the transfer of the item up to a predefined monetary amount.

Suitably, the unique identifier is a login name for an online service, web application or mobile app.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a schematic diagram of a computing device for use in embodiments of the present invention;

FIG. 2 is a schematic diagram of a network connected computer implemented system to manage postage according to embodiments of the present invention;

FIG. 3 is a flow diagram of a method performed using the system of FIG. 2;

FIG. 4 is a schematic diagram of a service, a dispatcher, a first user, a second user and a dispatcher performing steps of the method of FIG. 3;

FIG. 5 is flow diagram of an alternative method that can be performed using the system of FIG. 2;

FIG. 6 is flow diagram of another alternative method that can be performed using the system of FIG. 2;

FIG. 7 is flow diagram of another alternative method that can be performed using the system of FIG. 2; and

FIG. 8 is graphical user interface for implementing part of the method shown in FIG. 5.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF THE INVENTION

Embodiments of the present invention relate to systems and methods of managing sending of items between peers. In particular, the present invention relates to systems and methods of managing sending of items between peer users of an online service. The online service may be any service that requires a transfer of items between users. For example, the online service may be an online selling, trading, gifting, borrowing, bartering, swapping, renting, sharing or social networking service, or a service that provides a transfer of items, for example for businesses, consumers or any of these services.

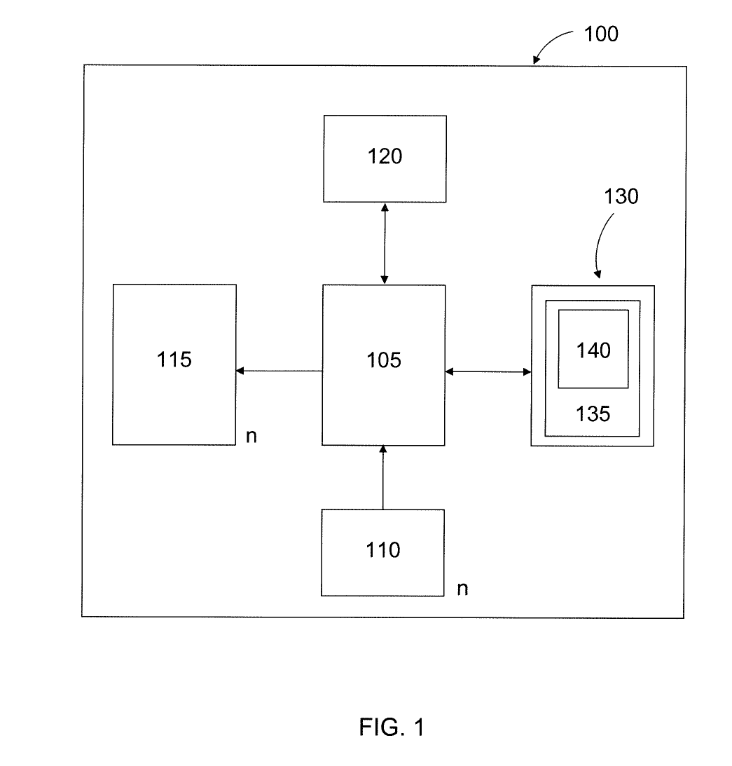

With reference to FIG. 1, a schematic diagram illustrates an apparatus in the form of a computing device 100, such as, but not limited to a laptop computer, personal computer, netbook, notebook, personal digital assistant (PDA), tablet PC having a touch sensitive screen, portable multimedia device, smartphone, tablet, phablet or other electronic device having appropriate known communication capabilities.

The computing device 100 comprises a processor 105 operatively coupled to one or more input devices 110, such as a mouse, keyboard, touch screen, controller and/or other suitable input device. One or more other input devices such as a scanner can be coupled to the processor 105 or to the computing device 100 if such input devices are not integral with the computing device 100. Processor 105 is operatively coupled to one or more output devices 115, such as a display screen. Touch screen 110 can also function as the display screen. One or more other output devices, such as a printer (not shown) can be coupled to the computing device 100. Processor 105 is also operatively coupled to a storage medium in the form of memory 130. Computing device 100 further comprises a communications device 120, such as a network card, antenna and/or other well known communication means to enable the computing device 100 to communicate with other computing devices via wired and/or wireless data connections.

Memory 130 comprises a computer readable medium 135, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as are well known in the art. The computer readable medium 135 comprises data and computer readable program code components 140 which are selectively executed to effect embodiments of the present invention described herein. In some embodiments, the computer readable code components are in the form of an app, for example on a mobile computing device such as a smart phone.

Persons skilled in the art will appreciate that the computing device 100 comprises other known elements required for the device to perform its known functions, but which are not shown in FIG. 1.

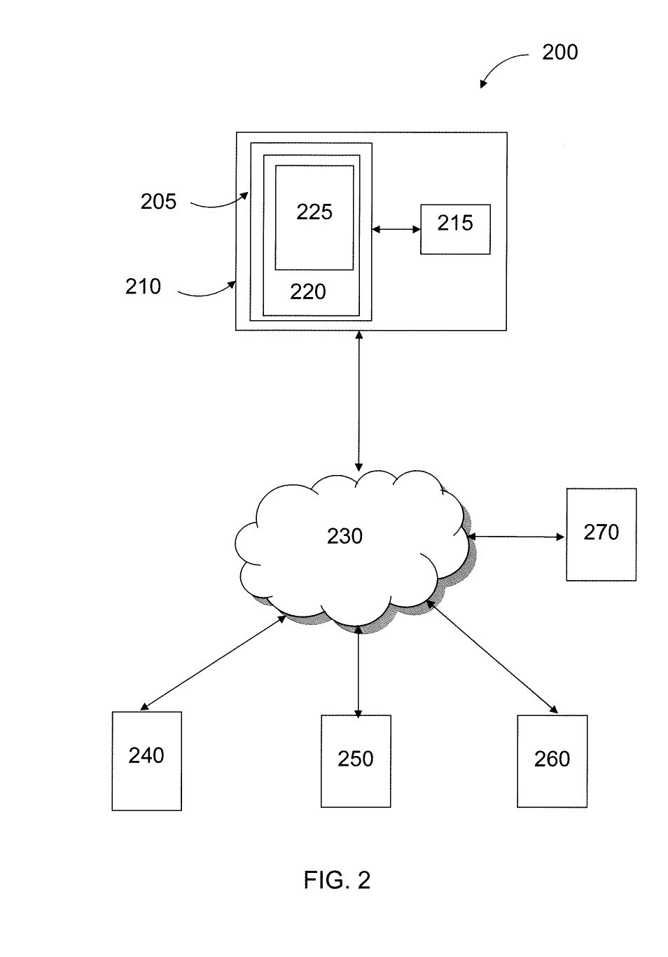

FIG. 2 is a schematic diagram illustrating a system 200 to manage sending of items between users of an online service in accordance with embodiments of the present invention. The system 200 comprises a server 210 of the online service to manage the sending of items, register users and perform other tasks related to the service. The server 210 is coupled to a communications network 230 to allow users and dispatchers to connect to the service. The communications network 230 may be a global communications network, such as the Internet, a private communications network or a combination thereof.

The server 210 comprises a processor 215 operatively coupled to a storage medium in the form of memory 205. Memory 205 comprises a computer readable medium 220, such as those described above in relation to computer readable medium 135. Computer readable medium 220 comprises computer readable program code components 225 to manage the sending of items between users of the online service in accordance with the teachings of the present invention. Computer readable medium 220 may further comprise, for example in a database, registration details of users of the service, such as names and locations, and records of items and transfers of items between users of the service. At least some of computer readable program code components 225 are selectively executed by the processor 215 and are configured to cause the execution of the embodiments of the present invention described herein.

A first computer 240 of a first user and a second computer 250 of a second user are coupled to be in communication with the server 210 via the communications network 230. In some embodiments, the first user and the second user may offer and/or request items for sale, sharing, borrowing or other transfer from one another via the server 210. A third computer 260 of a dispatcher is coupled to be in communication with the server via the communications network 230. The dispatcher receives physical items transferred from users of the service, such as the first user, and notifies the server 210 of the service via the third computer 260 that the items have been received. The dispatcher then transfers the items to other users of the service such as the second user. In some embodiments the dispatcher notifies the server 210 of the service of other information, such as details of the item. In some embodiments, the dispatcher can have a plurality of dispatch points located to improve the efficiency of the service.

In some embodiments a computer of a third party service 270, for example, a shipping service, a payment service and/or a separate online service, is coupled to be in communication with the server 210.

The first computer 240, the second computer 250, the third computer 260 and the computer of the third party service 270 can be computing devices as described above with reference to FIG. 1 and can be connected to the communications network 230 via conventional wireless and/or wired connections as are well known in the art.

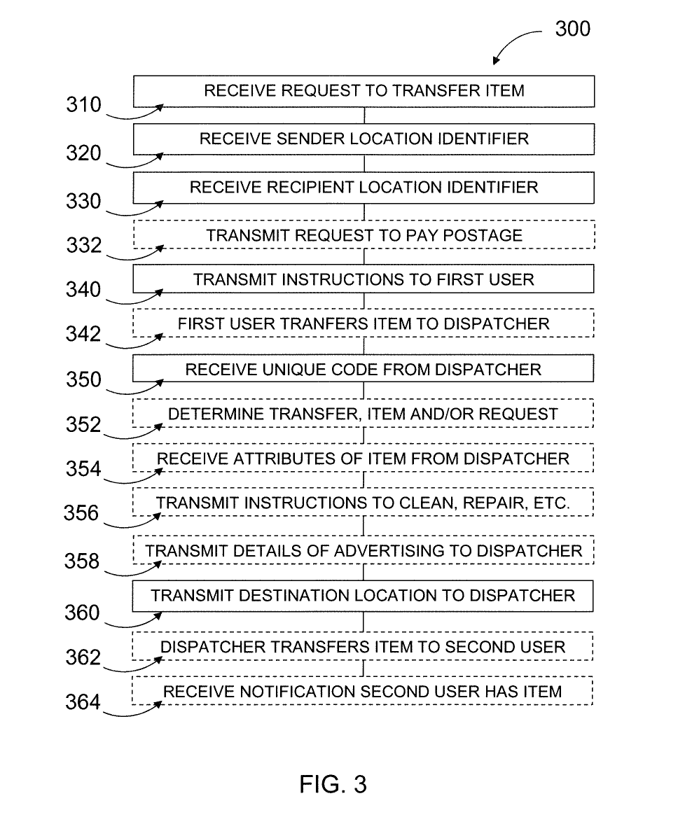

FIG. 3 is a schematic diagram illustrating a method 300 to manage sending of items between users of an online service in accordance with embodiments of the present invention. In the method 300 an item is transferred from the first user to the second user of the service via the dispatcher. The method enables the service to manage, monitor and/or verify the transfer of the item.

At step 310, the service receives at the server 210 via the communications network 230 a request to transfer an item from the first user to the second user. The request to transfer the item is received from the second computer 250 of the second user, the first computer 240 of the first user, another computing device of the service or a third party service 270 shown in FIG. 2, for example, an online selling, trading, gifting, borrowing, bartering, swapping, renting or sharing service. In some embodiments the first user and/or the second user are users of the service and the third party service 270. In some embodiments, the request comprises a transfer method identifier to identify how the item is to be transferred. The transfer method identifier identifies a method of transfer from the first user to the dispatcher and/or a method of transfer from the dispatcher to the second user. In some embodiments the transfer method identifier corresponds to selections transmitted from the first user, the second user and/or the party paying the transfer fee to the service or the third party service 270.

In some embodiments when the request to transfer the item is received from the second computer 250 by the sever 210 the server transmits a notification of the request to the first computer 240 of the first user. The first user then transmits an approval of the request to the server 210 to enable the server to proceed with the method. In some embodiments the request to transfer the item from the first user to the second user includes confirmation that a transfer fee has been paid. In some embodiments the service provides information to a third party service 270 about a payment fee and/or the transfer fee in advance of the request to transfer the item.

At step 320, the service receives at the server 210 via the communications network 230 from the first computer 240 a first location identifier of the first user. The first location identifier may identify a country, a region, a city, a town, a suburb, a post code, an address, a GPS location or other location detail of the first user. In some embodiments, the first location identifier is received by the server 210 during registration of the first user to the service. In some embodiments the first location identifier is received in response to a request transmitted to the first computer 240 from the server 210, for example after the request to transfer the item.

In some embodiments, the first location identifier is used to determine available transfer methods for transferring the item from the first user to the dispatcher. For example, the transfer methods may include postage, drop off, for example at a service station or supermarket, or pickup by a transfer service, such as by courier or unmanned aircraft, or by other services, such as a milk delivery, paper delivery, garbage collection, or other regular service. In some embodiments the item is forwarded to the dispatcher from the other service. In some embodiments the dispatcher retrieves the item directly from the first user or the other service. In some embodiments the other service transmits a notification to the dispatcher that the item is at the other service. In some embodiments the transfer methods for transferring the item from the first user to the dispatcher are chosen based on information received from the first user, the second user and/or a third party who are paying the transfer fee.

In some embodiments the first location identifier is used to determine a location of a dispatch point to which the first user posts the item or drops the item off. The server may determine the dispatch point that is closest to the location of the first user, has the fastest postage time from the location of the first user and/or has the lowest cost of postage from the location of the first user. In some embodiments the postage address of the dispatcher is a reply-paid or cash on delivery address. In some embodiments the server transfers, by post or other means, a prepaid envelope, satchel or parcel to the first user to enable the first user to post the item without purchasing postage.

At step 330, the service receives at the server 210 via the communications network 230 from the second computer 250 a second location identifier of the second user. The second location identifier may identify a country, a region, a city, a town, a suburb, a post code, an address, a GPS location or other location detail of the second user. In some embodiments, the second location identifier is received by the server 210 during registration of the second user to the service. In some embodiments the second location identifier is received in response to a request transmitted to the second computer 250 from the server 210, for example after the request to transfer the item.

In some embodiments, the second location identifier is used to determine available transfer methods for transferring the item from the dispatcher to the second user, for example via postage, pickup, such as from a service station, supermarket or 24 hour post locker, or drop off by the service, such as by courier or unmanned aircraft, or by other services, such as a milk delivery, paper delivery, garbage collection, or other regular service. In some embodiments the transfer methods for transferring the item from the dispatcher to the second user are chosen based on information received from the second user, the first user and/or a third party who are paying the transfer fee.

In some embodiments the second location identifier is used by the server 210 to determine a destination location, such as a destination address, of the postage or other means of transfer.

In some embodiments, the first location identifier and/or second location identifier are received via a computing device of a third party service 270 that is connecting to the service to facilitate transfer of the item. In some embodiments the first location identifier and/or the second location identifier are used by the server 210 to determine a transfer fee, such as a postage fee, for transferring the item. The transfer fee may be calculated prior to the receipt of the request to transfer the item in order to enable a user or users, for example the first user and/or the second user to decide to undertake the transfer.

At step 332, the service transmits from the server 210 via the communications network 230 to the first computer 240, second computer 250 and/or a computing device of a third party, for example a manufacturer or distributer of the item or a payment website, a request to pay a transfer fee. In some embodiments the request to transfer the item at step 310 includes a notification that the transfer fee has already been paid. In some embodiments the transfer fee is shared between multiple users and/or third parties. The transfer fee provides for the cost of transfer from a location of the first user to a location of the second user via the dispatcher. In some embodiments the transfer fee is a postage fee, for example for postage from the location of the first user to the location of the second user via a dispatch point of the dispatcher. In some embodiments a subscription to the service by the first user, the second user or a third party is used to pay a transfer fee. In some embodiments, the service manages import and/or export of the item, for example by charging one of the users or a third party for any taxes or duties. This charge may be included in the transfer fee. The service may also arrange insurance for the item during the transfer and include this in the transfer fee.

At step 340, the service transmits from the server 210 via the communications network 230 to the first computer 240 of the first user instructions to transfer the item to the dispatcher.

In some embodiments the instructions include a code corresponding to or identifying the item, the request or the transfer of the item. The code can be unique to allow tracking of the item. The code can be a text code, a word code, an alphanumeric code, a barcode, a quick response (QR) code or another suitable code.

In some embodiments the code has a coding redundancy to enable the code to be decoded when the code on the package is not completely legible or is damaged in some way. In some embodiments the code is formulated so that it can be understood by and transcribed by a human using handwriting with a low probability of transcription errors, for example the code may involve the use of words and natural language to encode the transaction.

In some embodiments the first user writes the code, for example an easy-to-write or easy-to-read code, on the item to identify the transfer. In some embodiments the first user can print the code to attach to the item to identify the transfer. In some embodiments the code corresponds to an identifier in the item or package, for example a radio frequency identifier (RFID), and the first user transmits the code to the server 210. In some embodiments the identifier is placed in the item during manufacture, by a user of the service or by the service during a transfer.

In some embodiments the instructions include a location, such as an address, of a dispatch point of the dispatcher. In some embodiments the dispatch point is a reply-paid or cash-on-delivery address.

At step 342, the first user transfers the item to the dispatcher. The first user may post, drop off, for example at a service station or supermarket, or have the item picked up by the service, a courier service or unmanned aircraft or by other services, such as a milk delivery or paper delivery service, garbage collection, or other regular service typically in accordance with the instructions and/or the transfer method identifier. The item may be transferred by postage in a standard postage box, at a post office or by another standard method of postage.

The dispatcher receives the item from the first user. In some embodiments the dispatcher pays a postage fee for postage of the item to enable the first user to post the item without purchasing postage, such as through a reply-paid or cash-on-delivery postal solution, or through stamps or prepaid envelopes, parcels or satchels.

In some embodiments the dispatcher is a postal or courier service. In some embodiments the item is received by the dispatcher at a distribution centre of the postal service or the courier service, or at a location associated with the first location identifier. In some embodiments, the distribution center of the postal or courier service has been modified to communicate with the server 210 and perform the dispatching functions described. In some embodiments the dispatcher is a mobile dispatching point used by a courier pick-up service, with the dispatching steps occurring during or immediately after the pick-up process.

At step 350, when or after the item is received by the dispatcher, the dispatcher reads the code from the item and transmits the code from the third computer 260 via the communications network 230 to the server 210 to notify the service that the item has been received by the dispatcher. In some embodiments the code is a text code, a word code, an alphanumeric code, a barcode, a quick response (QR) code and/or other suitable code. In some embodiments the code is determined from an RFID in the item or the package. The RFID is read from the item or package using any RFID reading means commonly known in the art.

In some embodiments, the destination location and/or the code is transmitted to the dispatcher by the server prior to the dispatcher receiving the item and/or in anticipation of the dispatcher receiving the item. In these embodiments, the dispatcher matches the code on the item to the code previously received by the server to determine the destination location. In some embodiments, the dispatcher sends an acknowledgement that an item having the code has been received to the server 210 via the communications network 230.

The code may be read off the item or package by the dispatcher and entered into the third computer or read into the third computer 260 from the item or package by a scanner or other appropriate means. In some embodiments, the dispatcher scans the code, for example the text code or word code, using optical character recognition to convert the code into text. In other embodiments, the dispatcher scans the code and the server uses optical character recognition to convert the code into text.

At step 352, the server 210 determines the transfer, item and/or request corresponding to the code. In some embodiments at step 352 the service transmits an update to the first user, the second user and/or a third party service 270 describing the status of the item or transfer to enable the first user, the second user and/or the third party to track the transfer of the item. In some embodiments the server or one of the other computing devices posts the status of the item or transfer to a social network service, website and/or microblog on behalf of the first user, the second user or a third party. In some embodiments, the service also records the legal transfer of ownership of item from one user to another, for example to a database of the server 210.

At step 354, the dispatcher transmits from the third computer 260 to the server 210 one or more attributes of the item, such as the weight of the item, the condition of the item, the condition of the packaging, confirmation that the item is the correct item, or other suitable attributes. The dispatcher can also inspect the item for safety, security or other purpose using explosives detection, x-ray or other chemical analysis or imaging techniques. In some embodiments the dispatcher transfers to the server 210 or the service 210 transfers to the dispatcher export and/or import details of the item, for example when the item is transferred internationally from the first user and/or when the item is to be transferred internationally to the second user.

At step 356, the service transmits from the server 210 or another computing device to the third computer 260 instructions to modify the item, such as to clean, repair, gift wrap and/or group items, or perform other functions relating to the item, the first user and/or the second user. In some embodiments codes of other transfers to be received by the second user are transmitted from the server to the dispatcher to enable the dispatcher to transfer a plurality of items to the second user as a single transfer. In some embodiments the service transmits from the server 210 to the third computer 260 instructions to open the package and separate and/or label a plurality of items within the package. The plurality of items are then transferred to a plurality of second users, for example in step 360.

At step 358, the service transmits from the server or another computing device to the third computer details of advertising to be attached to the item or package. In some embodiments, the details of advertising contain advertising to be printed by the dispatcher. In some embodiment the details of advertising instruct the dispatcher to select an advertisement from a selection of advertisements available to the dispatcher. In some embodiments the advertising relates to the item, the location of the second user, or other details of the transfer. In some embodiments, the advertising comprises samples or vouchers.

At step 360, the server 210 transmits location data referring to and/or identifying a destination location, such as the address of the second user or a location of a pickup point, such as a supermarket, post office, 24 hour post locker or service station, via the communications network 230 to the third computer 260 to enable the dispatcher to transfer the item to the second user. In some embodiments, the dispatcher attaches or writes the destination location on the item or package containing the item or implants the destination location into the item or package in an electronic form, for example, via a barcode or an RFID device. The dispatcher may also put the item into a new package to protect the item. In some embodiments this package can be reusable to enable the second user to transfer another item in the package, for example, in accordance with method 300.

At step 362, the dispatcher transfers the item to the second user. In some embodiments where a transfer method has been selected, the dispatcher transfers the item to the second user via the corresponding transfer method.

At step 364, in some embodiments, the second user transmits a notification to the server 210 from the second computer 250 to notify the service that the second user has received the item. In some embodiments the second user transmits feedback to the service, such as a quality rating of the item or a quality rating of the item's packing for transfer by the first user. In some embodiments the notification comprises the feedback. In some embodiments the item is delivered alongside another delivery to the second user. For example, delivery alongside another delivery can be specified by the first user, second user or third party in the transfer method.

It will be appreciated that no fixed order has been stated for the steps of method 300 and that these steps can be performed in a different order to the order in which they have been numbered and/or described.

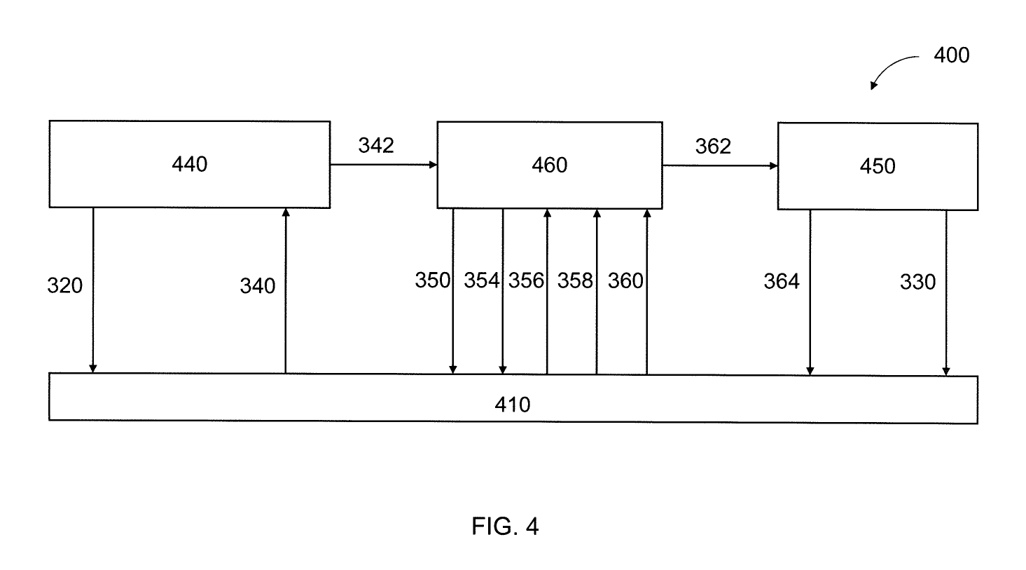

FIG. 4 is a schematic diagram of a preferred embodiment of the method. FIG. 4 illustrates the service 410, the dispatcher 460, the first user 440 and the second user 450 performing preferred steps of the method shown in FIG. 3.

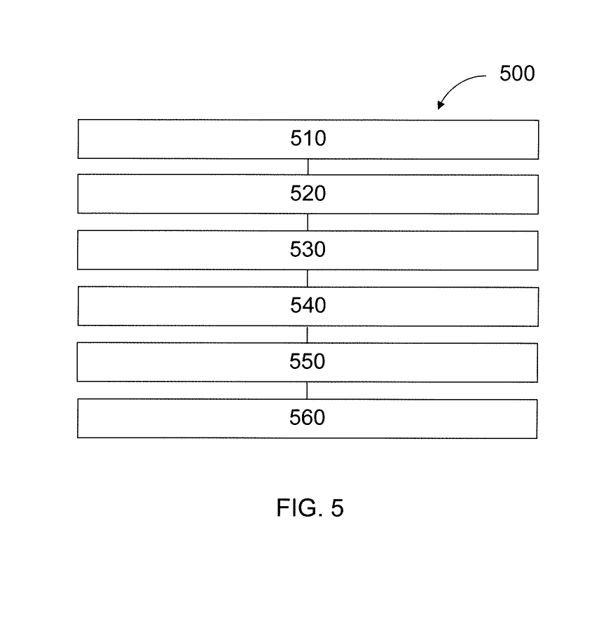

FIG. 5 is a flow diagram of a method 500 of managing sending of items according to another aspect of the present invention. In preferred embodiments, this aspect is particularly suited to managing sending of items between peers, and more particularly to managing sending of items without the peers having to share location information with one another. In some embodiments, the peers are members of an online service. However, generally the method can be applied where a first internet user has a second internet user's contact information other than their physical location or address. For example, such contact information can be a telephone number or an identifier of the second user for receiving messages via an online service, such as email, Skype, Viber, WhatsApp, Facebook, Google Plus or other similar services. The method 500 comprises the following steps.

At step 510, a request to transfer an item is received at a server of a service from a first user. The server can be similar to the server 210 or the computing device 100 described above.

At step 520, a location identifier of the first user is received at the server from a first user. In preferred embodiments, the location identifier of the first user is received in response to a request for the location identifier of the first user that is transmitted from the server to the first user. In preferred embodiments, the location identifier of the first user identifies a street address or a postal address. However, in alternative embodiments, the location identifier of the first user can identify a general location, a suburb, a postal code, GPS coordinates or other location information.

In some embodiments, contact information of the first user other than a location identifier is received at the server from the first user. The contact information of the first user is associated with a communication mechanism, such as telephone, short message service (SMS) or an online service, such as email, Skype, Viber, WhatsApp, Facebook, Google Plus or another similar online service. For example, the contact information of the first user and/or the second user can include a telephone number or an identifier for receiving messages via an online service. For example, the identifier can be an email address or an identifier, such as a login name, for Skype, Viber, WhatsApp, Facebook, Google Plus or another similar online service.

Subsequently, one or more requests from the server to the first user can be transmitted via the communication mechanism using the contact information. In some embodiments, the contact information of the first user is received in response to a request for contact information of the first user other than a location identifier that is transmitted from the server to the first user.

At step 530, contact information of a second user other than a location identifier is received at the server from a first user. The contact information is associated with a communication mechanism, such as those described above in step 520. Subsequently, one or more requests from the server to the second user can be transmitted via the communication mechanism using the contact information. In some embodiments, the contact information of the second user is received in response to a request for the contact information of the second user other than a location identifier that is transmitted from the server to the first user.

At step 540, a request for a location identifier of the second user is transmitted from the server to the second user via the communication mechanism using the contact information. In some embodiments, a request for confirmation that the second user wishes for the item to be transferred is also transmitted from the server to the second user via the communication mechanism using the contact information.

In some embodiments, the request includes a link directing the second user to a web page of the server relating to the transfer of the item and the web page provides a field in which the second user can enter the location identifier of the second user and post it to the server.

At step 550, the location identifier of the second user is received at the server from the second user. In preferred embodiments, the location identifier of the second user identifies a street address or a postal address. However, in alternative embodiments, the location identifier of the second user can identify a general location, a suburb, a postal code, GPS coordinates or other location information. In some embodiments, the confirmation that the second user wishes for the item to be transferred is received at the server from the second user.

In some embodiments, the service transmits additional requests to, and receives additional data from, the first user or the second user to confirm any further details regarding the location identifier of the first user or the second user.

At step 560, the location identifier of the first user and the location identifier of the second user are transmitted from the server to a transfer service. This enables the transfer service to transfer the item between the users. The item is transferred between a first location associated with the location identifier of the first user and a second location associated with the location identifier of the second user. For example, the item can be transferred by postage, drop off, for example, at a service station or supermarket, or pickup by the transfer service, such as by courier or unmanned aircraft, or by other services, such as a milk delivery, paper delivery, garbage collection, or another regular service.

In some embodiments, the first user is the sender of the item and the second user is the recipient of the item. In these embodiments, the item is collected from the first location by the transfer service and delivered to the second location.

In alternative embodiments, the second user is the sender of the item and the first user is the recipient of the item. In these embodiments, the item is collected from the second location by the transfer service and delivered to the first location.

In preferred embodiments, a request for a collection time is transmitted from the server to the first user or the second user and the collection time is received at the server from the first user or the second user. To enable the transfer service to pick up the item at the collection time the collection time is transmitted from the server to the transfer service.

The method can include additional steps to the steps specified. For example, in some embodiments, a request to specify whether the contact information or the location identifier of the first user or the second user is provided to the other user is transmitted from the server to the first user or the second user. In some embodiments, confirmation that the contact information and/or the location identifier of the first user is not to be provided to the second user is received at the server from the first user and the contact information of the first user is withheld from the second user. In some embodiments, confirmation that the contact information and/or the location identifier of the second user is not to be provided to the first user is received at the server from the first user and the contact information of the second user is withheld from the first user. Alternatively, the first user and/or the second user may not request that their contact information be withheld from the other user and the contact information of the first user and/or the second user is transmitted from the server to the other user.

The method can also include the step of the server calculating a postage cost from the location identifier of the first user and the location identifier of the second user. In preferred embodiments, a request to specify whether the first user, the second user, or a third party, will pay for the transfer of the item is transmitted from the server to the first user. In some embodiments, confirmation that the first user will pay for the transfer of the item is received at the server from the first user and a request for payment for the transfer of the item is transmitted from the server to the first user. In some embodiments, confirmation that a third party will pay for the transfer of the item is received at the server from the first user and a request for payment for the transfer of the item is transmitted from the server to the third party. A skilled addressee will appreciate that the request for payment can be for payment via any known payment method, for example, credit card, Paypal, bank transfer or another known payment method. In alternative embodiments, confirmation that the second user will pay for the transfer of the item is received at the server from the first user and a request for payment for the transfer of the item is transmitted from the server to the second user.

In preferred embodiments, the payment for the transfer of the item is a first flat rate where the addresses of the first user and the second user are in the same city, and a second flat rate where the addresses of the first user and the second user are in different cities of the same country.

In some embodiments, the service charges an additional payment for not providing the contact information of the first user or the second user to the other user.

In some embodiments, a unique code and instructions instructing the user to put the unique code on the item are transmitted from the server to the user from which the item is to be collected. The unique code can be any of the unique codes described in relation to method 300. In some embodiments, the instructions also include instructions for transferring the item to the transfer service.

In some embodiments, insurance is provided by the service covering loss or damage during the transfer of the item up to a predefined monetary amount.

In preferred embodiments, the item to be transferred must have a weight or volume that is less than a specified maximum weight or maximum volume. For example, the maximum weight can be 5 kg and the maximum volume can be 0.16 cubic metres.

In some embodiments, where an item exceeds the maximum weight or volume or the predefined monetary amount, an additional payment is requested by the server.

In some embodiments, the server stores the location identifier and/or the contact information of the first user and/or the second user for future uses of the service. The server can comprise a database in which the stored location identifier of one or more users is associated with the contact information other than location identifiers of the one or more users. The location identifier of the first user and/or the location identifier of the second user can be determined via the database for subsequent transfers of items.

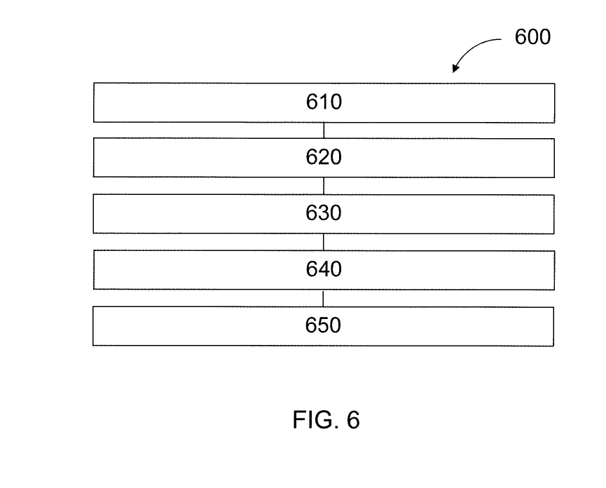

FIG. 6 is a flow diagram of a method 600 of managing sending of items between internet users according to an alternative embodiment of the method 500 which does not require the first user to provide the email address or contact information of the second user to the server. The method 600 comprises the following steps.

At step 610, a request to transfer an item is received at a server of a service. This step is equivalent to step 510 of method 500.

At step 620, a location identifier of the first user is received at a server of a service. This step is equivalent to step 520 of method 500.

At step 630, a unique code for the first user to provide to a second user is transmitted from the server to the first user. The unique code can be any of the unique codes described in relation to method 300. In preferred embodiments, the unique code identifiers the transfer of the item.

At step 640, the unique code and a location identifier of the second user are received at the server from the second user. In preferred embodiments, the server matches the unique code to the transfer of the item to enable the server to perform step 650. For example, in some embodiments, the second user visits a web page of the server. On the web page the server requests a unique code and/or a location identifier. The second user enters the unique code and/or a location identifier into the webpage and clicks a button to transmit the unique code and the location identifier to the server. The unique code is then used to identify the relevant transfer of an item.

At step 650, the location identifier of the first user and the location identifier of the second user are transmitted from the server to a transfer service. This step is equivalent to step 560 of method 500 and enables the transfer service to transfer the item between the users.

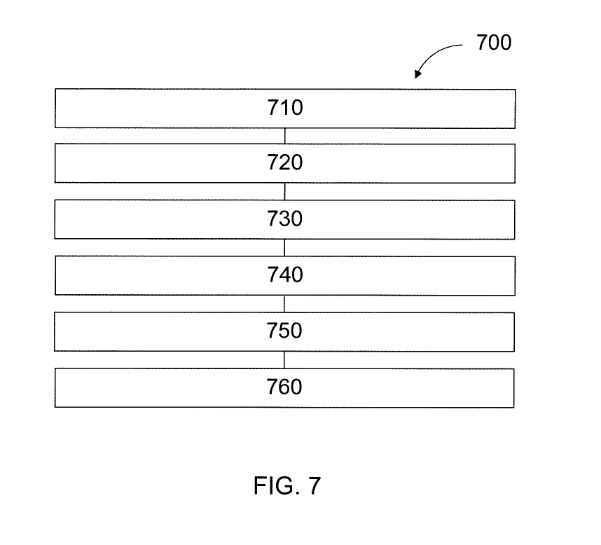

FIG. 7 shows another alternative method 700 of managing sending of items. The method 700 comprises the following steps.

At step 710, a request to transfer an item is received at a server of a service from a first user. This step is equivalent to step 510 of method 500 and step 610 of method 600.

At step 720, a unique identifier of the first user other than a location identifier is received at the server from the first user. In preferred embodiments, the unique identifier is associated with a communication mechanism, such as the communication mechanisms described above in step 520. For example, the unique identifier can be an email address, a telephone number or an identifier for Skype, Viber, WhatsApp, Facebook, Google Plus or another similar online service

At step 730, a unique identifier of a second user other than a location identifier is received at the server from the first user. The unique identifier may be associated with a communication mechanism, such as the communication mechanisms described above in step 520.

At step 740, a location identifier of the first user corresponding to the unique identifier of the first user is determined via the server. For example, the server can determine the location identifier from the unique identifier via a database lookup using a database of location identifiers and unique identifiers as described above.

At step 750, a location identifier of the second user corresponding to the unique identifier of the second user is determined via the server. The location identifier can be determined via the methods described in step 740.

At step 760, the location identifier of the first user and the location identifier of the second user are transmitted from the server to a transfer service. This step is equivalent to step 560 of method 500 and step 650 of method 600, and enables the transfer service to transfer the item between the users.

Skilled addressees will appreciate that many of the embodiments mentioned with regards to method 500 can also be applied to method 600 and method 700 and that method 500, method 600 and method 700 may be combined. For example, in some embodiments, the unique code of method 600 can be the same unique code as used in method 500.

Skilled addressees will also appreciate that embodiments of method 500, method 600 and method 700 can be combined with embodiments of method 300. For example, when the transfer service receives the item, the transfer service can read the unique code from the item and transmit the code to the server to notify the service that the item has been received. In some embodiments, the service can subsequently transmit to the transfer service the location corresponding to the location identifier of the recipient to enable the transfer service to transfer the item to the recipient.

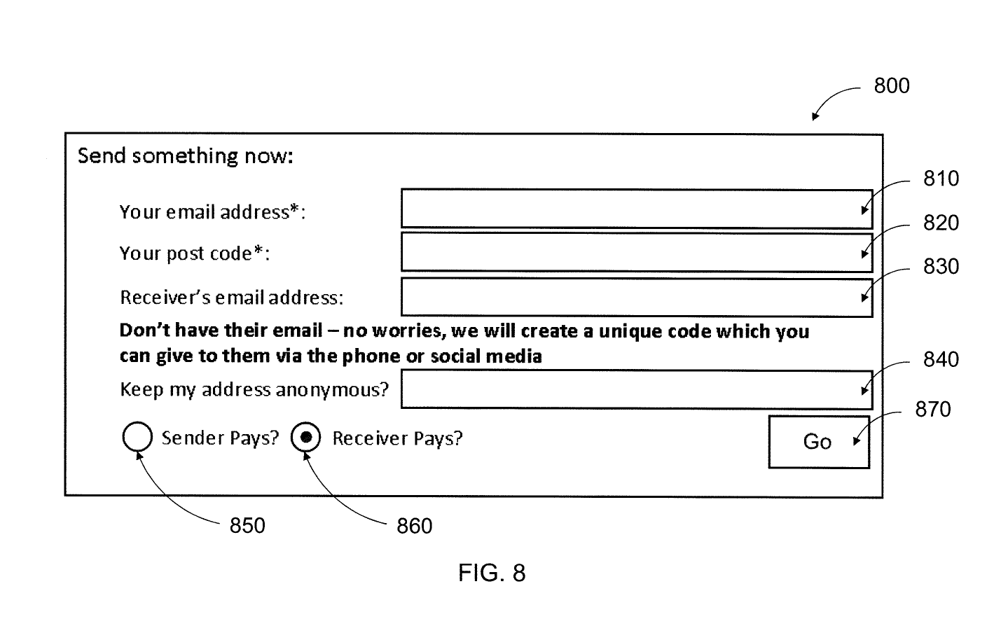

FIG. 8 is an example graphical user interface (GUI) 800 for implementing steps 520 and 530 of the method 500 according to an embodiment of the present invention. The GUI 800 is displayed to the first user and in preferred embodiments is displayed on a web page. Location information of the first user, in the form of an email address, is entered into a first text field 810. A location identifier of the first user, in the form of a post code, is entered into a second text field 820. Optionally, an email address of the second user is entered into a text field 830. If no email address is entered, the first user is provided with a unique code to provide to the second user.

A radio button is provided to enable the first user to select sender pays 850 or receiver pays 860. The first user can choose to keep their email address anonymous from the second user by typing “Y” or “Yes” in a fourth text field 840. Alternatively, the first user can choose not to keep their email address anonymous from the second user by typing “N” or “No” in the fourth text field 840.

A button 870 is provided to transmit the information in the text fields 810, 820, 830, 840 and the selection of the radio button 850, 860 from the first user to the server.

A similar graphical user interface or web page can be used to implement transmission of the location identifier of the second user at step 540 and the location identifier of the first user 520 of the method 500 and other similar steps in methods 500, 600 and 700.

Embodiments of the present invention thus benefit owners of online services, users of online services and society as a whole by providing accountable, payment-flexible, easy and anonymous sending of items between users of online services. The invention provides the further benefit of allowing an online service to monitor attributes of items transferred between users, for example to track the movement of items on a sharing service, gather statistical information to improve the service, and provide value-added services on or around the item as it is being transferred, such as measurement, cleaning, repair or advertising services.

A further benefit of embodiments of the present invention is that a first user can send an item to a second user without the first user or the second user knowing each other's identity and without the first user needing to purchase stamps or prepaid postage. The first user, the second user and/or a third party can also flexibly choose the method of postage providing additional convenience and efficiency. Furthermore, embodiments of the present invention can be performed without the cost and/or inconvenience of software integration or arrangements with a shipping company.

In this specification, adjectives such as first and second, step numbers, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

In this specification, the terms “comprises”, “comprising” or similar terms are intended to mean a non-exclusive inclusion, such that an apparatus that comprises a list of elements does not include those elements solely, but may well include other elements not listed.

The reference to any prior art in this specification is not, and should not be taken as, an acknowledgement or any form of suggestion that the prior art forms part of the common general knowledge.

Throughout the specification the aim has been to describe the invention without limiting the invention to any one embodiment or specific collection of features. Persons skilled in the relevant art may realize variations from the specific embodiments that will nonetheless fall within the scope of the invention.

1. A method of managing sending of items between users of an online service, the method comprising:
receiving at a server of the service a request to transfer an item from a first user to a second user;
receiving at the server from the second user a second location identifier of the second user;
transmitting from the server to the first user instructions to transfer the item to a dispatcher;
receiving at the server from the dispatcher a code to notify the service that the item has been received by the dispatcher; and
transmitting from the server to the dispatcher location data corresponding to the second location identifier that corresponds to the code to enable the dispatcher to transfer the item to the second user.

2. The method of claim 1, wherein the code is read from the item.

3. The method of claim 1, further comprising: transmitting the code from the server to the first user.

4. The method of claim 1, wherein the code;
corresponds to the request or the transfer of the item;
is unique to the request, the transfer of the item and/or the location identifier of the second user;
has a coding redundancy to enable the code to be decoded when the code is not completely legible or is damaged in some way; and/or
is a text code to enable the first user to write the code on the item or on a package containing the item.

5-6. (canceled)

7. The method of claim 1, wherein the code is read from the item by the dispatcher scanning the code.

8. (canceled)

9. The method of claim 1, wherein the location data is;
transmitted from the server to the third computer in response to the reception of the code at the server from the third computer; and/or
transmitted from the server to the third computer with the unique code prior to the reception of the code at the server from the third computer.

10. (canceled)

11. The method of claim 1, wherein the second location identifier identifies an address, a city, a region, a post code, and/or a GPS location.

12-16. (canceled)

17. The method of claim 1, further comprising: transmitting from the server to the second user, first user and/or a third party a request to pay a transfer fee.

18-19. (canceled)

20. The method of claim 17, wherein the instructions to transfer the item from the first user to the dispatcher, and/or the instructions to transfer the item from the dispatcher to the second user, are determined from the party paying the transfer fee for the transfer.

21-24. (canceled)

25. The method of claim 17, wherein the instructions to transfer the item from the dispatcher to the second user are determined from a selection of a second transfer method received by the server from the first user, the second user or the party paying the transfer fee.

26. The method of claim 25, wherein the second transfer method is by one of the following:
postage or courier from the dispatcher to the second user; and
pick up the second user from the dispatcher or another location.

27. (canceled)

28. The method of claim 1, wherein there are a plurality of dispatching points located to improve the efficiency of the service.

29. The method of claim 1, wherein the dispatcher is a postal service or a courier service.

30. (canceled)

31. The method of claim 1, further comprising: receiving at the server from the dispatcher one or more attributes of the item.

32. The method of claim 31, wherein the one or more attributes of the item include a weight of the item and/or a condition of the item.

33. (canceled)

34. The method of claim 1, further comprising: transmitting from the server to the dispatcher one or more of the following:
instructions to modify the item;
details of advertising to be attached to the item or on a package containing the item;
codes of other transfers to be received by the second user to enable the dispatcher to transfer a plurality of items to the second user as single transfer.

35. The method of claim 34, wherein the instructions to modify the item include instructions to clean, repair or gift wrap the item.

36-37. (canceled)

38. The method of claim 1, wherein the dispatcher receives a plurality of items from the first user and distributes the items to a plurality of second users.

39. The method of claim 1, further comprising;
transmitting from the server to the first user, the second user and/or a third party an update to enable the first user, the second user and/or the third party to track the transfer of the item; and/or
posting, via the server, a status of the item to a social network service, website or microblog on behalf of the first user, the second user or a third party.

40. (canceled)

41. The method of claim 1, further comprising receiving at the server from the second user, a rating of the quality of the item or the packing of the item by the first user.

42. A system to manage sending of items between users of an online service, the system comprising:
a server of the service, the server coupled to a communications network; and
a first computer of a first user, a second computer of a second user and a third computer of a dispatcher coupled to the server via the communications network; and
wherein the server:
receives via the communications network a request to transfer an item from the first user to the second user;
receives via the communications network a second location identifier of the second user from the second computer;
transmits via the communications network to the first computer instructions to transfer the item to a dispatcher;
receives via the communications network from the third computer a code to notify the service that the item has been received by the dispatcher; and
transmits via the communications network to the third computer location data corresponding to the second location identifier corresponding to the code to enable the dispatcher to transfer the item to the second user.

43-70. (canceled)

71. The method of claim 1, wherein the instructions to transfer the item from the first user to the dispatcher are determined from a selection of a first transfer method received by the server from the first user and/or the second user.

72. The method of claim 71, wherein the first transfer method is one of the following:
receiver-pays postage from the first user to the dispatcher;
pick up of the item from a location of the first user corresponding to a first location identifier;
drop off by the first user at the dispatcher or another location specified in the instructions.

73. The method claim 72, further comprising: receiving at the server from the first user the first location identifier.

74. The method of claim 72, wherein the first location identifier identifies a region, a city, a country, a post code, an address and/or a GPS location.
